(19) United States
(12) Patent Application Publication
(10) Pub. No.: US 2020/0024888 A1
(43) Pub. Date: Jan. 23, 2020

(54) ELECTRONIC SAFE ASSEMBLY

(71) Applicant: David Kinnebrew, Indianapolis, IN (US)

(72) Inventor: David Kinnebrew, Indianapolis, IN (US)

(21) Appl. No.: 16/037,630

(22) Filed: Jul. 17, 2018

(51) Int. Cl. E05G 1/10; E05G 1/04; E05B 37/00; E05B 39/00; G08B 25/12; G08B 25/10

(52) U.S. Cl. CPC E05G 1/10; E05G 1/04; E05B 37/00; E05Y 2400/664; G08B 25/12; G08B 25/10; E05Y 2400/85; E05B 39/00

(57) ABSTRACT

An electronic safe assembly includes a safe that has a door is hingedly thereto for storing valuables. A control circuit is coupled to the door and the control circuit stores a first code and a second code. A keyboard is coupled to the door for entering an alpha numeric code and the keyboard is electrically coupled to the control circuit. The control circuit receives a first input when the first code is entered with the keyboard and the control circuit receives a second input when the second code is entered into the keyboard. A locking unit is coupled to the door and the locking unit is electrically coupled to the control circuit. The locking unit is in communication with an extrinsic communication network to selectively contact emergency responders. The locking unit engages the safe when the door is closed thereby locking the door. The locking unit disengages the safe when either of the first or second codes is entered with the keyboard. Moreover, the locking unit transmits a distress call over the extrinsic communication network when the second code is entered to notify the emergency responders that the safe has been opened under duress.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to safe devices and more particularly pertains to a new safe device for discretely contacting emergency responders when a safe is opened under duress.

### BRIEF SUMMARY OF THE INVENTION

An embodiment of the disclosure meets the needs presented above by generally comprising a safe that has a door is hingedly thereto for storing valuables. A control circuit is coupled to the door and the control circuit stores a first code and a second code. A keyboard is coupled to the door for entering an alpha numeric code and the keyboard is electrically coupled to the control circuit. The control circuit receives a first input when the first code is entered with the keyboard and the control circuit receives a second input when the second code is entered into the keyboard. A locking unit is coupled to the door and the locking unit is electrically coupled to the control circuit. The locking unit is in communication with an extrinsic communication network to selectively contact emergency responders. The locking unit engages the safe when the door is closed thereby locking the door. The locking unit disengages the safe when either of the first or second codes is entered with the keyboard. Moreover, the locking unit transmits a distress call over the extrinsic communication network when the second code is entered to notify the emergency responders that the safe has been opened under duress.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an electronic safe assembly according to an embodiment of the disclosure.

FIG. 2 is a right side phantom view of an embodiment of the disclosure.

FIG. 3 is a top view of an embodiment of the disclosure.

FIG. 4 is a perspective in-use view of an embodiment of the disclosure.

FIG. 5 is a schematic view of an embodiment of the disclosure.

### DETAILED DESCRIPTION OF THE INVENTION

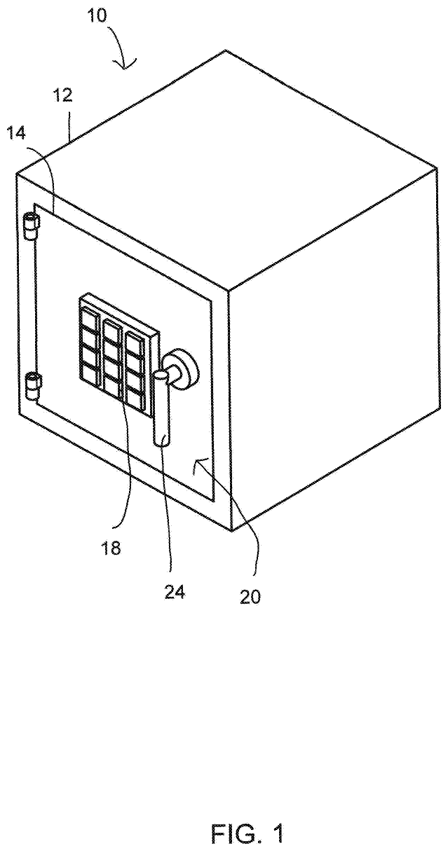

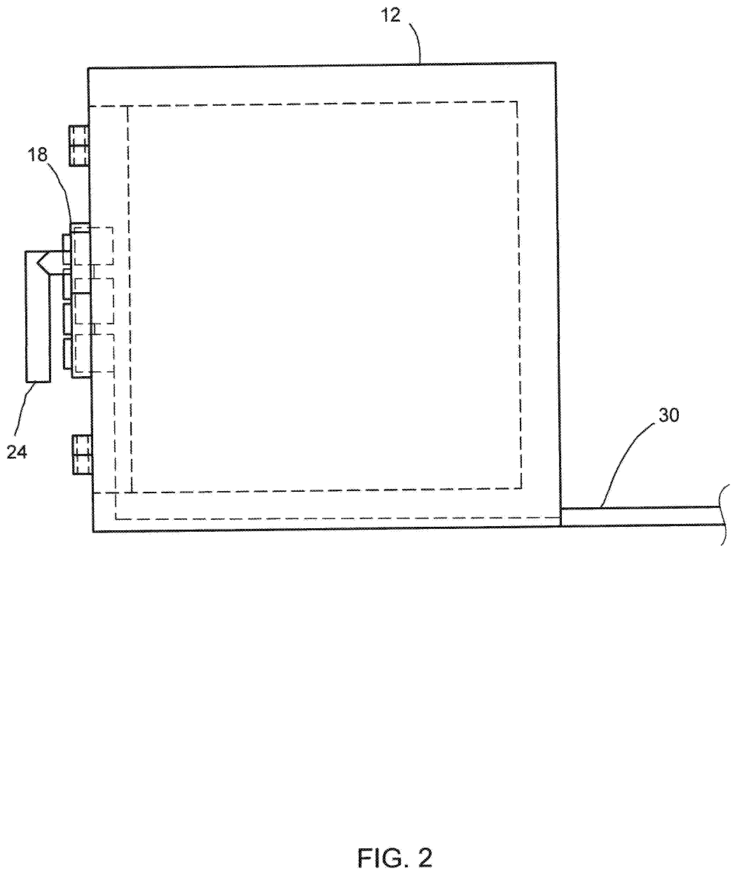

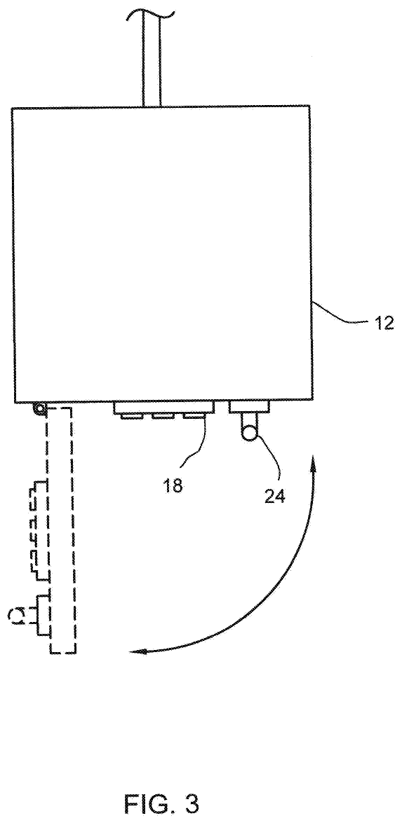

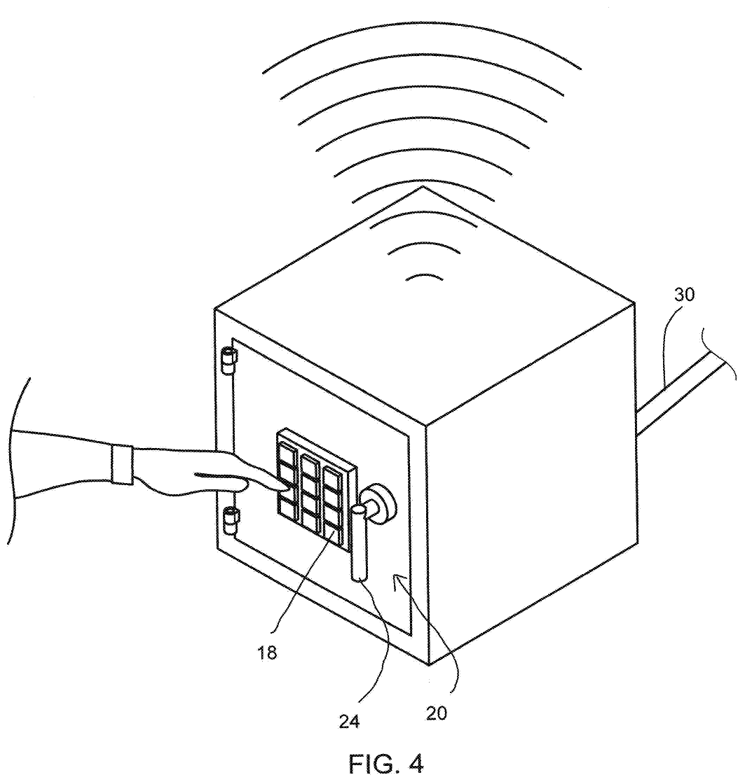

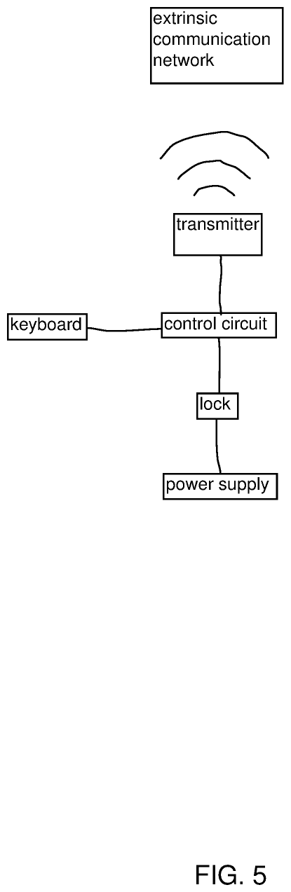

With reference now to the drawings, and in particular to FIGS. 1 through 5 thereof, a new safe device embodying the principles and concepts of an embodiment of the disclosure and generally designated by the reference numeral 10 will be described.

As best illustrated in FIGS. 1 through 5, the electronic safe assembly 10 generally comprises a safe 12 that has a door 14 hingedly coupled thereto for storing valuables. The safe 12 may be positioned in a building, such as a gas station, casino, bar or other location that could be subject to robbery. A control circuit 16 is coupled to the door 14 and the control circuit 16 stores a first code and a second code. Each of the first and second codes may be pre-determined, alpha numeric codes.

A keyboard 18 is coupled to the door 14 for entering an alpha numeric code and the keyboard 18 is electrically coupled to the control circuit 16. The control circuit 16 receives a first input when the first code is entered with the keyboard 18. Additionally, the control circuit 16 receives a second input when the second code is entered into the keyboard 18. The keyboard 18 may include a plurality of alpha numeric keys, the keyboard 18 may be a touch screen or the keyboard 18 may comprise any electronic device that is capable of communicating the alpha numeric code to the control circuit 16.

A locking unit 20 is coupled to the door 14 and the locking unit 20 is electrically coupled to the control circuit 16. The locking unit 20 is in communication with an extrinsic communication network 22 for selectively contacting emergency responders, such as local police. The locking unit 20 engages the safe 12 when the door 14 is closed thereby locking the door 14. The locking unit 20 disengages the safe 12 when the first code is entered with the keyboard 18 and the locking unit 20 disengages the safe 12 when the second code is entered. Moreover, the locking unit 20 transmits a distress call over the extrinsic communication network 22 when the second code is entered. In this way the locking unit 20 notifies the emergency responders that the safe 12 has been opened under duress.

The locking unit 20 comprises a lock 24 that is coupled to the door 14 and the lock 24 is electrically coupled to the control circuit 16. The control circuit 16 turns the lock 24 off when the control circuit 16 receives either of the first input or the second input. Thus, the door 14 can be opened for accessing contents of the safe 12. The lock 24 may be an electronic lock 24 of any conventional design that is common to safes.

A transmitter 26 is coupled to the door 14 and the transmitter 26 is electrically coupled to the control circuit 16. The transmitter 26 is in communication with the extrinsic communication network 22 and the transmitter 26 transmits the distress call when the control circuit 16 receives the second input. The transmitter 26 may be a radio frequency transmitter 26 or the like and the transmitter 26 may employ a WPAN signal. Moreover, the extrinsic communication network 22 may be the internet, a cellular phone network 22 and any other means of electronic mass communication. A power supply 28 is coupled to the door 14, the power supply 28 is electrically coupled to the control circuit 16 and the power supply 28 comprises a power cord 30 extending away from the safe 12 and being electrically coupled to a power source.

In use, the first code is entered into the keyboard 18 any time the safe 12 needs to be opened under normal circumstances. The control circuit 16 receives the first input when the first code is entered into the keyboard 18 thereby unlock 24ing the safe 12. The second code is entered into the keyboard 18 any time the safe 12 is opened under duress, such as an armed robbery. The control circuit 16 receives the second input when the second code is entered into the keyboard 18. Thus, the safe 12 is unlocked and the transmitter 26 communicates the distress call to the emergency responders. In this way an attendant of the safe 12, such as an employee or the like, can discretely contact police during a robbery without letting the robber know that the police have been contacted. Thus, the employee's safety is protected during the robbery.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An electronic safe assembly having a pair of alpha numeric codes, one of which will discretely contact police when said safe is opened, said assembly comprising:
a safe having a door being hingedly coupled thereto for storing valuables;
a control circuit being coupled to said door, said control circuit storing a first code and a second code;
a keyboard being coupled to said door for entering an alpha numeric code, said keyboard being electrically coupled to said control circuit, said control circuit receiving a first input when said first code is entered with said keyboard, said control circuit receiving a second input when said second code is entered into said keyboard; and
a locking unit being coupled to said door, said locking unit being electrically coupled to said control circuit, said locking unit being in communication with an extrinsic communication network wherein said locking unit is configured to selectively contact emergency responders, said locking unit engaging said safe when said door is closed thereby locking said door, said locking unit disengaging said safe when said first code is entered with said keyboard, said locking unit disengaging said safe when said second code is entered, said locking unit transmitting a distress call over the extrinsic communication network when said second code is entered wherein said locking unit is configured to notify the emergency responders that said safe has been opened under duress.

2. The assembly according to claim 1, wherein said locking unit comprises a lock being coupled to said door, said lock being electrically coupled to said control circuit, said lock control circuit turning said lock off when said control circuit receives either of said first input or said second input thereby facilitating said door to be opened.

3. The assembly according to claim 2, wherein said locking unit further comprises a transmitter being coupled to said door, said transmitter being electrically coupled to said control circuit, said transmitter being in communication with the extrinsic communication network, said transmitter transmitting said distress call when said control circuit receives said second input.

4. The assembly according to claim 1, further comprising a power supply being coupled to said door said power supply being electrically coupled to said control circuit, said power supply comprising a power cord extending away from said safe and being electrically coupled to a power source.

5. An electronic safe assembly having a pair of alpha numeric codes, one of which will discretely contact police when said safe is opened, said assembly comprising:
a safe having a door being hingedly coupled thereto for storing valuables;
a control circuit being coupled to said door, said control circuit storing a first code and a second code;
a keyboard being coupled to said door for entering an alpha numeric code, said keyboard being electrically coupled to said control circuit, said control circuit receiving a first input when said first code is entered with said keyboard, said control circuit receiving a second input when said second code is entered into said keyboard; and
a locking unit being coupled to said door, said locking unit being electrically coupled to said control circuit, said locking unit being in communication with an extrinsic communication network wherein said locking unit is configured to selectively contact emergency responders, said locking unit engaging said safe when said door is closed thereby locking said door, said locking unit disengaging said safe when said first code is entered with said keyboard, said locking unit disengaging said safe when said second code is entered, said locking unit transmitting a distress call over the extrinsic communication network when said second code is entered wherein said locking unit is configured to notify the emergency responders that said safe has been opened under duress, said locking unit comprising:
a lock being coupled to said door, said lock being electrically coupled to said control circuit, said lock control circuit turning said lock off when said control circuit receives either of said first input or said second input thereby facilitating said door to be opened;
a transmitter being coupled to said door, said transmitter being electrically coupled to said control circuit, said transmitter being in communication with the extrinsic communication network, said transmitter transmitting said distress call when said control circuit receives said second input; and
a power supply being coupled to said door said power supply being electrically coupled to said control circuit, said power supply comprising a power cord extending away from said safe and being electrically coupled to a power source.
